(19) United States
(12) Patent Application Publication
(10) Pub. No.: US 2026/0160626 A1
(43) Pub. Date: Jun. 11, 2026

(54) SENSOR DEVICE

(71) Applicant: Kistler Holding AG, Winterthur (CH)

(72) Inventors: Pirouz Sohi, Winterthur (CH); Hanspeter Oldrati, Wangi (CH); Roland Sommer, Neftenbach (CH)

(21) Appl. No.: 19/406,288

(22) Filed: Dec. 2, 2025

(30) Foreign Application Priority Data
Dec. 6, 2024 (EP) 24217960.4

(51) Int. Cl. G01L 9/00; G01K 7/16; G01L 19/00

(52) U.S. Cl. CPC G01L 9/008; G01K 7/16; G01L 19/0092

(57) ABSTRACT

A sensor device for measuring a pressure includes a base body and a sensor material. A region of the base body forms a base body diaphragm that undergoes a deflection to sense the pressure. The sensor material is mechanically coupled to a region of the base body diaphragm and generates piezoelectric charge under the effect of the deflection in proportion to the value of the measured pressure. Near the base body diaphragm is an electrical conductor that undergoes a change in resistance proportional to the temperature.

### TECHNICAL FIELD

The invention relates to a sensor device that detects pressure from charges generated from piezoelectric material and includes an electrical conductor that changes resistance proportional to temperature changes.

### BACKGROUND OF THE INVENTION

Sensor devices are well known. They are used in a variety of ways to measure a pressure, a temperature and the like.

Thus, sensor devices are known which measure a pressure according to the piezoelectric measuring principle. For this purpose, they comprise piezoelectric material such as quartz (SiO₂), gallium orthophosphate (GaPO₄) and the like which generates piezoelectric charges under the effect of the pressure to be measured. The piezoelectric charges are generated on the surfaces of the piezoelectric material and are tapped by means of electrodes. The quantity of piezoelectric charges generated is proportional to the magnitude of the measured pressure.

Piezoelectric materials such as SiO₂ and GaPO₄ exhibit a very high profile rigidity. Due to this very high profile rigidity, piezoelectric sensor devices have a high natural frequency of more than 500 kilohertz (kHz). Due to this high natural frequency, piezoelectric sensor devices are predestined for dynamic pressure measurements. As a rule, the maximum measuring frequency of the sensor device employing piezoelectric material is ⅓ of the natural frequency of the pressure variations being measured by the sensor device.

Such a piezoelectric sensor device for the dynamic measurement of pressure is sold by the applicant under the designation Type 603C. In type 603C, the piezoelectric material in the form of a plurality of disks is spaced apart from a diaphragm in the axial direction by a base plate. The pressure to be measured acts as a force on the piezoelectric material via said diaphragm and said base plate. As the piezoelectric material such as SiO₂ and GaPO₄ is brittle and can break under local pressure peaks, the base plate ensures an even distribution of the pressure on the piezoelectric material. The maximum measuring frequency of type 603C is about 200 kHz. The technical specifications of type 603C are documented in data sheet 603C_003-288e-11.22.

### OBJECTS AND SUMMARY OF THE INVENTION

Now, users of sensor devices for measuring pressure wish to further increase the measurement frequency (also known as the measuring frequency), which is the number of pressure measurements that the sensor device can process per unit of time.

It accordingly is one of the principal objects of the present invention to provide a sensor device having a measuring frequency of significantly more than 200 kHz for measuring the pressure.

This primary object is achieved by the features described herein.

The invention relates to a sensor device configured for measuring a pressure and including at least one base body and at least one sensor material. At least one region of the base body is configured as a base body diaphragm. Such base body diaphragm is configured to undergo a deflection from the pressure to be measured and thus sense the pressure to be measured. The sensor material is carried on the base body diaphragm and configured to generate piezoelectric charge under the effect of the deflection of said base body diaphragm such that a magnitude of the generated piezoelectric charge is proportional to the magnitude of the measured pressure. The sensor device includes at least one electrical conductor carried on the base body, wherein a change in resistance of the electrical conductor is proportional to the value of the measured temperature to be measured by the sensor device.

Advantageous embodiments of the invention are described below with greater elaboration on more of their particulars.

### BRIEF DESCRIPTION OF THE DRAWINGS

In the following, the invention is explained in more detail by way of example with reference to the Figures in which

FIG. 1 shows a plan view of part of a first embodiment of a sensor device 1 with a pressure sensor 1P for measuring a pressure P and with a temperature sensor 1T for measuring a temperature T;

FIG. 2 shows a cross-section of a part of the sensor device 1 as shown in FIG. 1 along a section path A-A;

FIG. 3 shows a cross-section of a part of the sensor device 1 as shown in FIG. 1 along a section path B-B;

FIG. 4 shows a plan view of part of a second embodiment of a sensor device 1 with a pressure sensor 1P for measuring a pressure P, with a temperature sensor 1T for measuring a temperature T, and with a compensator 1K;

FIG. 5 shows a cross-section of a part of the sensor device 1 as shown in FIG. 5 along a section path C - C;

FIG. 6 shows a cross-section of a part of the sensor device 1 as shown in FIG. 5 along a section path D-D;

FIG. 7 shows a plan view of part of a third embodiment of a sensor device 1 with a group of pressure sensors 1P and with a temperature sensor 1T as shown in FIGS. 1 to 3;.

FIG. 8 shows a plan view of part of a fourth embodiment of a sensor device 1 with a group of pressure sensors 1P, with a temperature sensor 1T, and with a group of compensators 1K as shown in FIGS. 4 to 6;

FIG. 9 shows a curve of the generation of pyroelectric charge P20+, P30+, P20−, P30− under the effect of a temperature change ΔT of the sensor device 1 as shown in FIGS. 4 to 6 and 8;

FIG. 10 shows a temperature-dependent non-linear sensitivity curve σ of the sensor device 1 with a pressure sensor 1P as shown in FIGS. 1, 2, 4, 5, 7, and 8;

FIG. 11 shows a schematic circuit diagram of a part of the first embodiments of the sensor device 1 with a pressure sensor 1P as shown in FIGS. 1 and 2, with a transmission device 5, with a transducer unit 6, and with an evaluation unit 7;

FIG. 12 shows a schematic circuit diagram of part of the embodiments of the sensor device 1 with a temperature sensor 1T as shown in FIGS. 1, 3, 4, 6, 7, and 8, with a transmission device 5, with a transducer unit 6, and with an evaluation unit 7;

FIG. 13 shows a schematic circuit diagram of a part of the second embodiment of the sensor device 1 with a pressure sensor 1P and with a compensator 1K as shown in FIGS. 4 and 5, with a transmission device 5, with a transducer unit 6, and with an evaluation unit 7;

FIG. 14 shows a schematic circuit diagram of a part of the third embodiment of the sensor device 1 with a group of pressure sensors 1P as shown in FIG. 7, with a transmission device 5, with a transducer unit 6, and with an evaluation unit 7; and

FIG. 15 shows a schematic circuit diagram of a part of the fourth embodiment of the sensor device 1 with a group of pressure sensors 1P and a group of compensators 1K as shown in FIG. 8, with a transmission device 5, with a transducer unit 6, and with an evaluation unit 7.

Throughout the figures, identical reference numerals denote identical objects in the Figures.

### DETAILED DESCRIPTION OF EXEMPLARY EMBODIMENTS OF THE INVENTION

The sensor device 1 is configured to perform the function of measuring a pressure P and a temperature T.

According to the first to fourth embodiments, the sensor device 1 comprises at least one pressure sensor 1P for measuring the pressure P and at least one temperature sensor 1T for measuring the temperature T. According to the second and fourth embodiments, said sensor device 1 also comprises at least one compensator 1K.

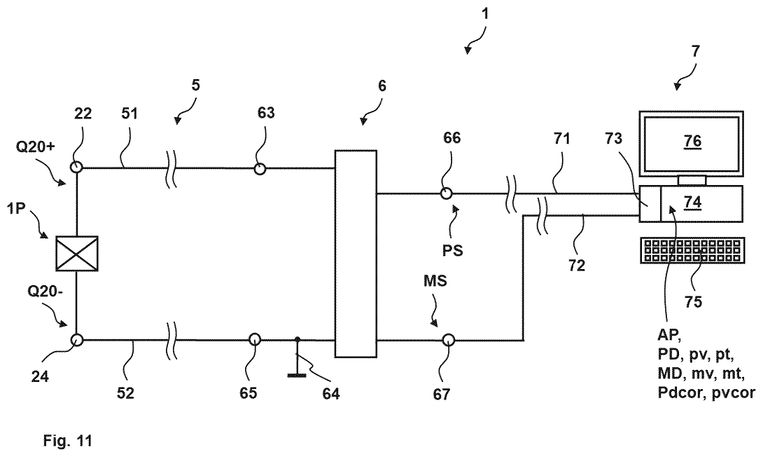

Furthermore, said sensor device 1 as shown in FIGS. 11 to 15 comprises at least one transmission device 5, at least one transducer unit 6 and at least one evaluation unit 7.

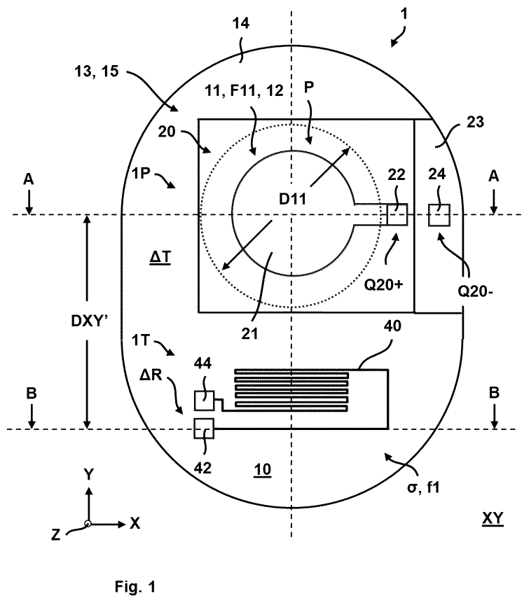

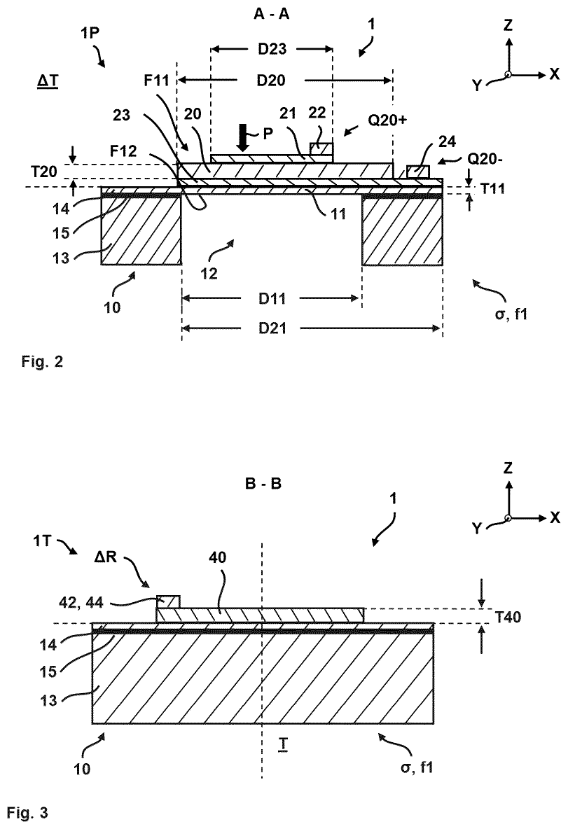

In FIGS. 1 to 8, said sensor device 1 is shown in a three-dimensional coordinate system with a horizontal axis X, a transverse axis Y and a vertical axis Z, which is also a longitudinal axis Z that aligns with the direction of the force to be measured on account of the pressure P. The three axes X, Y, Z are perpendicular to each other. The horizontal axis X and the transverse axis Y span a horizontal plane XY. FIGS. 1, 4, 7 and 8 show embodiments of said sensor device 1 in plan view in the horizontal plane XY. FIGS. 2, 3, 5 and 6 show said sensor device 1 in cross-section.

### The Base Body 10

The sensor device 1 comprises at least one base body 10 that is configured to perform the function of sensing the pressure P to be measured.

Said base body 10 is made of electrically insulating material such as silicon, glass, and the like. Silicon has a specific electrical resistance of greater than or equal to 107 Ωm at room temperature (20° C.). Glass has a specific electrical resistance of greater than or equal to 1011 Ωm at 20° C.

Said base body 10 is defined by a front side and a rear side disposed opposite the front side. On the front side, the base body 10 is configured to form a supporting surface. Said supporting surface is located in the horizontal plane XY. Said supporting surface desirably defines an area that is less than or equal to 3 mm by 3 mm square, preferably less than or equal to 2 mm by 2 mm square. On the rear side, said base body 10 is configured to form a base body opening 12.

Preferably, said base body 10 is a Silicon On Insulator (SOI) comprising the following functional layers:
As schematically shown in FIG. 2, a supporting layer 13 consists of a silicon layer that defines a thickness measured along the vertical axis Z in the range 200 to 500 μm, preferably 400 μm. The supporting layer 13 is configured to perform a supporting function for components of the sensor device 1.
As schematically shown in FIG. 2, a boundary layer 14 made of silicon defines a thickness along the vertical axis Z in the range from 100 to 2 μm, and preferably it has a thickness of 50 μm, and preferably it has a thickness of 5 μm. Said boundary layer 14 is configured to perform the function of forming a base body diaphragm 11 in a region of the base body 10. Said boundary layer 14 delimits the base body 10 in the horizontal plane XY.
As schematically shown in FIG. 2, a stop layer 15 is configured with a thickness of 1 μm measured along the vertical axis Z and is arranged along the vertical axis Z between the supporting layer 13 and the boundary layer 14. Said stop layer 15 consists of an oxide material and has a specific electrical resistance of greater than or equal to 1012 Ωm at 20° C. Therefore, the function of the stop layer 15 is to electrically insulate the boundary layer 14 from the supporting layer 13. Said stop layer 15 is configured to perform the further function of an etch stop during the production of the base body opening 12 by chemical etching in the base body 10. Thereby, silicon is etched off along the vertical axis Z on the rear side of the base body 10 up to the stop layer 15.

The base body diaphragm 11 is designed to sense the pressure P to be measured. The base body diaphragm 11 is defined on opposite sides by two opposing surfaces F11, F12 that are spaced apart from each other in the direction along the longitudinal axis Z. The two surfaces F11, F12 define a front surface F11 and a rear surface F12. The front surface F11 is located on the front side of the base body 10 and lines parallel to the horizontal plane XY. The pressure P acts along the vertical axis Z on the front surface F11. The front surface F11 faces the direction in which the pressure P acts as schematically indicated by the direction along the bold typeface arrow designated P in FIG. 2. The rear surface of the base body diaphragm 11 defines the base body opening 12 on the rear side of the base body 10. Under the effect of the pressure P, said base body diaphragm 11 is configured to undergo a deflection along the vertical axis Z into the base body opening 12.

Said base body diaphragm 11 desirably is defined by a thickness T11 measured along the longitudinal axis Z of less than or equal to 20 μm, preferably less than or equal to 10 μm, preferably less than or equal to 5 μm. The base body diaphragm 11 desirably is defined by a diameter D11 of less than or equal to 300 μm measured parallel to the XY plane as schematically shown in FIG. 2, preferably less than or equal to 200 μm, preferably less than or equal to 100 μm. The ratio of thickness T11 to diameter D11 of the base body diaphragm 11 desirably is configured in such a manner that the sensor device 1 has a natural frequency f1 of greater than or equal to 1 MHz. Advantageously, the ratio of thickness T11 to diameter D11 of the base body diaphragm 11 is in the range from 1.7 10-2 to 5.0 10-2. Exemplary ratios of thickness T11 to diameter D11 of the base body diaphragm 11 lead to the following natural frequencies f1:
For a thickness T11 of the base body diaphragm 11 equal to 5 μm and a diameter D11 of the base body diaphragm 11 equal to 300 μm, the results are a ratio of thickness T11 to diameter D11 of the base body diaphragm 11 is equal to 1.7 10-2 and a natural frequency f1 of greater than 1 MHz.
For a thickness T11 of the base body diaphragm 11 equal to 5 μm and a diameter D11 of the base body diaphragm 11 equal to 200 μm, the results are a ratio of thickness T11 to diameter D11 of the base body diaphragm 11 is equal to 2.5 10-2 and a natural frequency f1 of greater than 2.5 MHz.
For a thickness T11 of the base body diaphragm 11 equal to 5 μm and a diameter D11 of the base body diaphragm 11 equal to 100 μm, the ratio of thickness T11 to diameter D11 of the base body diaphragm 11 is 5.0 10-2 and the natural frequency f1 is greater than 10 MHz.

In contrast to the piezoelectric sensor device of type 603C, which comprises a metallic diaphragm made of stainless steel 17-4PH, the base body diaphragm 11 according to the invention is made of silicon. Compared to stainless steel 17-4PH, which has a density of 7.8g/cm³, silicon has a density of 2.3g/cm³. Therefore, said base body diaphragm 11 according to the invention is more than three times lighter, which further increases the natural frequency f1 of said sensor device 1 as compared to the piezoelectric sensor device of type 603C.

### The Sensor Material 20

The sensor device 1 comprises a formation of at least one layer of sensor material 20. Said sensor material 20 is configured to perform the function of generating an electrical signal that lends itself to become resolved into a measured value representative of the pressure P to be measured.

Said sensor material 20 desirably is piezoelectric and consists of quartz (SiO₂), gallium orthophosphate (GaPO₄), calcium gallo germanate (Ca₃Ga₂Ge₄O₁₄ or CGG), langasite (La₃Ga₅SiO₁₄ or LGS), tourmaline, aluminum nitride (AlN), lead zirconate titanate (PZT), aluminum scandium nitride (Al(1-x)Sc(x)N with x=0 . . . 0.4), potassium sodium niobate (K(x)Na(1-x)NbO3 with x=0.2 . . . 0.5), and the like.

The sensor material 20 is configured to be carried by the base body 10. Preferably, said sensor material 20 is carried in mechanical contact with the front side of the base body 10 in at least one region of the base body diaphragm 11.

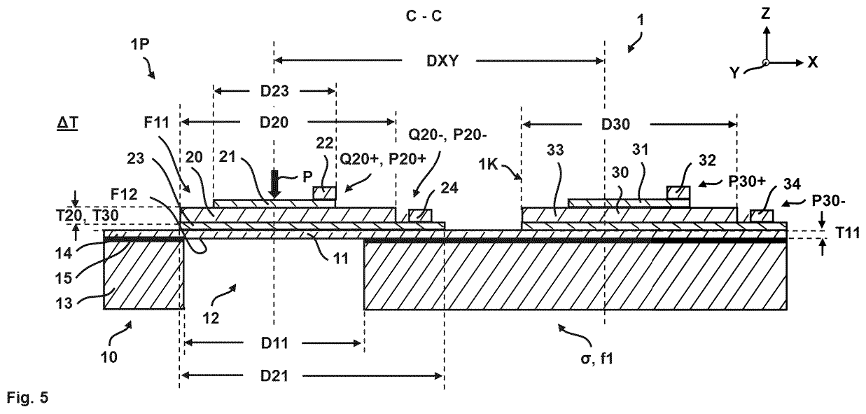

Preferably, as schematically shown in FIGS. 2 and 5 for example, said sensor material 20 is mechanically coupled to some areas on the front surface F11 of the base body diaphragm 11. Said sensor material 20 desirably is configured in the form of a layer extending in the horizontal plane XY. In the horizontal plane XY, the sensor material 20 defines a base area D20. The base area D20 is greater than or equal to the diameter D11 of the base body diaphragm 11. Said sensor material 20 is configured with a constant thickness T20 as measured along the vertical axis Z and schematically shown in FIGS. 2 and 5 for example. The thickness T20 is less than or equal to 10 μm, preferably the thickness T20 is less than or equal to 5 μm, preferably the thickness T20 is less than or equal to 1 μm.

This thickness T20 of the layer of sensor material 20 desirably is formed by a standard sputtering process. For example, for aluminium nitride (AlN) as sensor material 20, a rod made of aluminium (Al) is sputtered with an Argon (Ar) plasma. The aluminum rod is placed next to the whatever surface is to receive the layer of sensor material 20 up to the desired thickness T20. Due to the Argon-sputtering, small aluminum particles are ejected to that receiving surface. The entire set-up (Al-rod and receiving surface) is placed in a Nitrogen (N) atmosphere. In the nitrogen atmosphere, molecular and atomic nitrogen reacts with the aluminum particles and forms aluminum nitride (AlN) that adheres to the receiving surface, which can be a second sensor electrode 23 as schematically shown in FIG. 2 for example.

In the piezoelectric sensor device of type 603C, said sensor material is in the form of three disks, each being 0.2 mm thick and 3.5 mm in diameter. Viewed in the axial direction, the disks are spaced apart from the diaphragm by a metallic base plate being 0.6 mm thick and 3.5 mm in diameter. In further contrast to the piezoelectric sensor device of type 603, the sensor material 20 is arranged as a thin layer connected to the base body diaphragm 11 according to the invention. The thickness T20 of the thin layer is less than or equal to 10μm. This means that according to the present invention, there are no disks with sensor material and the metallic base plate is also omitted, which reduces the weight of the sensor device 1 according to the invention. And since the natural frequency f1 is inversely proportional to the weight of the sensor device 1, the natural frequency f1 of the sensor device 1 of the present invention increases due to the absence of the disks with sensor material and the metallic base plate.

Under the effect of the pressure P to be measured, said sensor material 20 is configured to generate piezoelectric charge Q20+, Q20− as the measured value. When the pressure P acts along the vertical axis Z on one side of the front surface F11 of the base body diaphragm 11, the base body diaphragm 11 is configured to undergo a deflection into the opening 12. In FIG. 2, the pressure P is schematically shown as an arrow. Said piezoelectric material 20 is configured to generate piezoelectric charge Q20+, Q20− under the effect of the deflection of the base body diaphragm 11. The magnitude of piezoelectric charge Q20+, Q20− generated is proportional to the value of the measured pressure P. The permanent operating temperature of the sensor material 20 is in the range from −40° C. to +500° C.

The sensor material 20 is configured to generate piezoelectric charge Q20+, Q20− on a plurality of surfaces of the sensor material 20, which surfaces are parallel to the horizontal plane XY. The piezoelectric charge Q20+, Q20− comprises first piezoelectric charge Q20+ and second piezoelectric charge Q20−. In the cross-section of FIG. 2, first piezoelectric charge Q20+ is generated on a surface of the sensor material 20 facing away from the base body diaphragm 11, and second piezoelectric charge Q20− is generated on a surface of the sensor material 20 facing the base body diaphragm 11. According to the following description, the first piezoelectric charge Q20+ is preferably transduced into a pressure signal PS, while the second piezoelectric charge Q20− is preferably used as a ground potential signal MS.

The sensitivity σ of the sensor device 1 is of great importance. The sensitivity σ is the ratio of the measured value to the input value of the pressure P to be measured. The sensitivity σ falls cubically with the increase in the thickness T11 of the base body diaphragm 11. And the sensitivity σ falls quadratically with the decrease in the diameter D11 of the base body diaphragm 11. Thus, the sensitivity σ of the sensor device 1 decreases with the increase in the ratio of the thickness T11 to the diameter D11 of the base body diaphragm 11.
For a thickness T11 of the base body diaphragm 11 equal to 5 μm and a diameter D11 of the base body diaphragm 11 equal to 300 μm and a resulting ratio of thickness T11 to diameter D11 of the base body diaphragm 11 equal to 1.7 10⁻², a sensitivity σ of the sensor device 1 of about 5 pC/bar follows.
For a thickness T11 of the base body diaphragm 11 equal to 5 μm and a diameter D11 of the base body diaphragm 11 equal to 200 μm and a resulting ratio of thickness T11 to diameter D11 of the base body diaphragm 11 equal to 2.5 10⁻², a sensitivity σ of the sensor device 1 of about 0.5 pC/bar follows.
For a thickness T11 of the base body diaphragm 11 equal to 5 μm and a diameter D11 of the base body diaphragm 11 equal to 100 μm and a resulting ratio of thickness T11 to diameter D11 of the base body diaphragm 11 equal to 5.0 10⁻², a sensitivity σ of the sensor device 1 of about 0.05 pC/bar follows.

### The Compensator Material 30

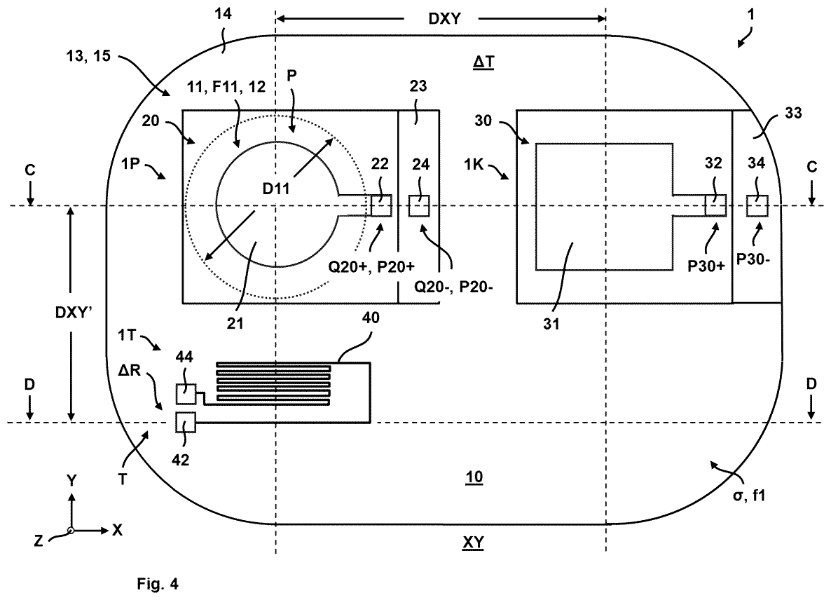

According to a second embodiment schematically shown in FIGS. 4 and 5 and a fourth embodiment schematically shown in FIG. 8, said sensor device 1 comprises at least one configuration of compensator material 30. The compensator material 30 is configured to perform the function of compensating for the pyroelectric effect of the sensor material 20 of the sensor device 1.

Certain sensor material 20 such as CGG, LGS, tourmaline, AlN, PZT, and the like, exhibits the direct and/or indirect pyroelectric effect, according to which a temperature change ΔT leads to the generation of pyroelectric charge P20+, P20− on a surface of the sensor material 20. The pyroelectric charge P20+, P20− is generated on the same surfaces of the sensor material 20 as the piezoelectric charge Q20+, Q20-. Therefore, the measurement of the pressure P is falsified by any change in temperature ΔT. In the second and fourth embodiments of the sensor device 1, the sensor material 20 exhibits the pyroelectric effect.

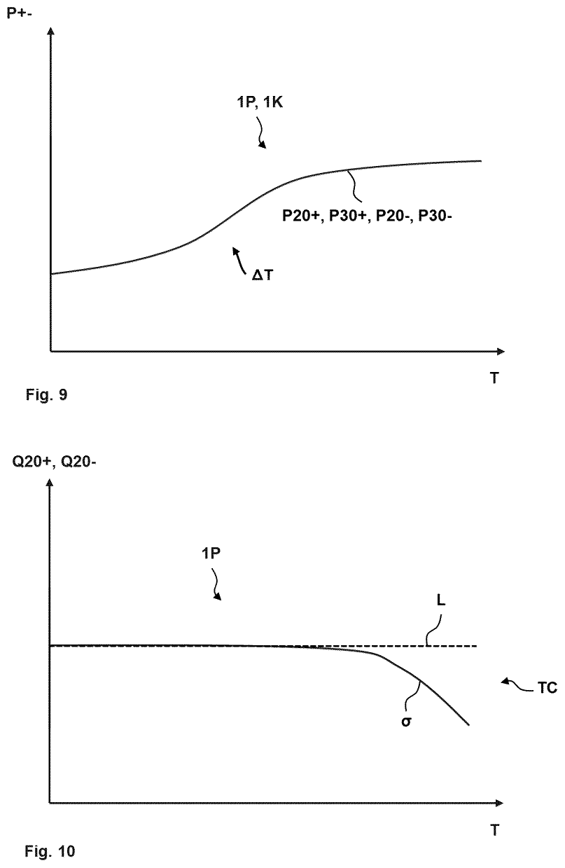

Then, said compensator material 30 preferably consists of the same CGS, LGS, tourmaline, AlN, PZT, and the like, as the sensor material 20. FIG. 9 shows a curve of the generation of pyroelectric charge P20+, P30+, P20−, P30− with the temperature change ΔT. The temperature T is plotted on the abscissa over the range of the permanent operating temperature of the sensor material 20 and the compensator material 30 from −40° C. to +500° C. The ordinate represents the pyroelectric charge P+−. The magnitude of pyroelectric charge P20+, P30+, P20−, P30− generated is proportional to the size of the base area D20 the sensor material 20 and to the size of a base area D30 of the compensator material of 30. For example, for a temperature change ΔT, the curve of the generation of pyroelectric charge P20+, P30+, P20−, P30− is S-shaped. The slope of the curve reflects the sensitivity of the sensor material 20 and the compensator material 30 to the pyroelectric effect. This sensitivity is in the range of from 0.1 picocoulomb per degree Celsius (pC/° C.) to 0.5 pC/° C.

Said layer of compensator material 30 is configured to be carried by the base body 10. Preferably, the compensator material 30 is carried so as to lie above at least one region on the front side of the base body 10. Preferably, the compensator material 30 is arranged spaced apart from the base body diaphragm 11 in a direction parallel to the horizontal plane define by the XY axes. Said compensator material 30 forms a layer extending in the horizontal plane XY. In the horizontal plane XY, the compensator material 30 is dimensioned to cover a base area D30. Preferably, the base area D30 is the same size as the base area D20 of the sensor material 20. Along the vertical axis Z, the compensator material 30 is configured to define a constant thickness T30. Preferably, the thickness T30 of the compensator material 30 is the same as the thickness T20 of the sensor material 20. The thickness T30 desirably is less than or equal to 10 μm, or preferably the thickness T30 is less than or equal to 5 μm, or preferably the thickness T30 is less than or equal to 1 μm.

This thickness T30 of the layer of compensator material 30 desirably is formed by a standard sputtering process. For example, for aluminium nitride (AlN) as compensator material 30, a rod made of aluminium (Al) is sputtered with an Argon (Ar) plasma. The aluminum rod is placed next to the whatever surface is to receive the layer of sensor material 20 up to the desired thickness T20. Due to the Argon-sputtering, small aluminum particles are ejected to that receiving surface. The entire set-up (Al-rod and receiving surface) is placed in a Nitrogen (N) atmosphere. In the nitrogen atmosphere, molecular and atomic nitrogen reacts with the aluminum particles and forms aluminum nitride (AlN) that adheres to the receiving surface, which can be second sensor electrode 23 as schematically shown in FIG. 2 for example.

Because the compensator material 30 is spaced apart from the base body diaphragm 11, the compensator material 30 does not experience any deflection due to the effect of the pressure P, and thus the compensator material 30 does not generate any piezoelectric charge as a measured value. Preferably, the sensor material 20 and the compensator material 30 have an identical structure. Preferably, the size and shape of the base area D20 of the sensor material 20 is equal to the size and shape of the base area D30 of said compensator material 30. Preferably, the ratio of the size of the base area D20 of the sensor material 20 to the size of the base area D30 of the compensator material 30 is known.

Just as with the sensor material 20, which is configured to generate the pyroelectric charge P20+, P20− on a plurality of surfaces parallel to the horizontal plane XY, the compensator material 30 also is configured to generate the pyroelectric charge P30+, P30− on a plurality of surfaces parallel to the horizontal plane XY. The pyroelectric charge P20+, P30+, P20−, P30− that is so generated, comprises first pyroelectric charge P20+, P30+ and second pyroelectric charge P20−, P30−. In the cross-section of FIG. 2, the first pyroelectric charge P20+ is generated on the surface of the sensor material 20 facing away from the base body diaphragm 11 and the second pyroelectric charge P20− is generated on the surface of the sensor material 20 facing the base body diaphragm 11. In the case of said compensator material 30 schematically shown in FIG. 5, first pyroelectric charge P30+is generated on a surface of compensator material 30 facing away from base body 10 and second pyroelectric charge P30− is generated on a surface of compensator material 30 facing said base body 10.

### The Pressure Sensor 1P

Said sensor device 1 comprises a plurality of sensor electrodes 21, 23. Said sensor electrodes 21, 23 are configured to perform the function of tapping, i.e., collecting and drawing off, the piezoelectric charge Q20+, Q20 − from the surfaces of the sensor material 20.

Said sensor electrodes 21, 23 are arranged in the region of the surfaces of the sensor material 20 where piezoelectric charge Q20+, Q20− is generated. The sensor electrodes 21, 23 comprise a first sensor electrode 21 and a second sensor electrode 23. The sensor electrodes 21, 23 are made of electrically conductive material such as silver (Ag), gold (Au), platinum (Pt), and the like and desirably can be created and put in place by any standard process such as chemical vapor deposition, physical vapor deposition or lithography.

In the cross-section of FIGS. 2 and 5, the first sensor electrode 21 lies against the surface of the sensor material 20 facing away from the base body diaphragm 11 and taps the first piezoelectric charge Q20+. The second sensor electrode 23 lies against the surface of the sensor material 20 facing the base body diaphragm 11 and taps the second piezoelectric charge Q20−. Each of the two sensor electrodes 21, 23 is configured to form a layer extending parallel to the horizontal plane XY. Parallel to the horizontal plane XY, the first sensor electrode 21 is defined by a first sensor base area D21, and the second sensor electrode 23 is defined by a second sensor base area D23. Along the vertical axis Z, each of the two sensor electrodes 21, 23 is defined by a constant thickness of less than or equal to 200 nm.

Compared to the piezoelectric sensor device of type 603C, the diaphragm of which has a diameter of 5.5 mm, the base body diaphragm 11 according to the invention is about one order of magnitude smaller. The base body diaphragm 11 is miniaturized. The surface of the diaphragm of type 603C has enough space for more than one hundred base body diaphragms 11 configured according to the invention. The base body diaphragm 11, the sensor material 20 carried by the base body diaphragm 11, and the sensor electrodes 21, 23 arranged on the surfaces of the sensor material 20 are configured to act in concert to form a miniaturized pressure sensor 1P which not only generates piezoelectric charge Q20+, Q20− for the pressure P to be measured, but which also comprises sensor electrodes 21, 23 in order to tap said piezoelectric charge Q20+, Q20− from the surfaces of the sensor material 20.

The profile rigidity of the base body diaphragm 11 is not constant across its diameter D11. In a central region of the base body diaphragm 11 along the vertical direction Z, the profile rigidity is constant, but in a peripheral region in the transition to the stop layer 15 and to the support layer 13, the profile rigidity increases from the rigidity in the central region. As the profile rigidity increases in the peripheral region of said base body diaphragm 11, the sensitivity σ of the sensor device 1 and thus also the generation of piezoelectric charge Q20+, Q20− decreases there. This decrease in the sensitivity σ of the sensor device 1 in the peripheral region of the base body diaphragm 11 falsifies the measurement of the pressure P. To avoid the decrease in the sensitivity σ of the sensor device 1 in the peripheral region of the base body diaphragm 11, preferably no first piezoelectric charge Q20+ is tapped there at all, which first piezoelectric charge Q20+ is preferably used as the pressure signal PS. For this reason, the diameter of the first sensor base area D21, on which the first piezoelectric charge Q20+ is tapped, is smaller than the diameter D11 of the base body diaphragm 11. Preferably, the first sensor base area D21 is less than or equal to 80%, preferably less than or equal to 60% of the diameter D11 of the base body diaphragm 11.

On the other hand, the second sensor base area D23, on which the second piezoelectric charge Q20-is tapped, which second piezoelectric charge Q20-is preferably used as the first ground potential signal MS, is preferably greater than or equal to the diameter D11 of the base body diaphragm 11.

The sensor device 1 comprises a plurality of sensor contact points 22, 24. Said sensor contact points 22, 24 are configured to perform the function of providing electrical contact between the sensor electrodes 21, 23 and the transmission device 5.

Said sensor contact points 22, 24 consist of electrically conductive material such as Ag, Au, Pt, and the like and desirably can be created and put in place by any standard process such as chemical vapor deposition, physical vapor deposition or

### Lithography.

The sensor contact points 22, 24 comprise a first sensor contact point 22 and a second sensor contact point 24. The first sensor contact point 22 rests against the first sensor electrode 21 and establishes an electrical contact with the first sensor electrode 21. The second sensor contact point 24 rests against the second sensor electrode 23 and establishes an electrical contact with the second sensor electrode 23. Each of the two sensor contact points 22, 24 is configured to define a planar extension parallel to the horizontal plane XY, which is designed to be large enough to accomplish electrical contacting such as thermosonic ball-wedge bonding, ultrasonic wedge-wedge bonding, and the like.

Said base body diaphragm 11, the sensor material 20 carried by the front surface F11 of the base body diaphragm 11, and the sensor electrodes 21, 23 that lie on the surfaces of the sensor material 20 are configured to act in concert to form the pressure sensor 1P of the first to fourth embodiments of the sensor device 1. The piezoelectric charge Q20+, Q20− is the measured value of the pressure sensor 1P. The continuous operating temperature of the pressure sensor 1P is in the range of from −40° C. to +500° C.

The sensitivity σ of the pressure sensor 1P is the ratio of the measured value to the input variable of the pressure P to be measured. As shown in FIG. 10, the sensitivity σ is temperature-dependent. The abscissa shows the temperature T over the range of the continuous operating temperature of the sensor material 20 from −40° C. to +500° C. The ordinate shows the magnitude of piezoelectric charge Q20+, Q20− generated. The sensitivity σ forms a non-linear curve, for example. The sensor material 20 generates less piezoelectric charge Q20+, Q20− as the temperature T rises. The measurement of the pressure P is falsified by this temperature-dependent non-linearity of the sensitivity σ of the pressure sensor 1P.

To correct the temperature-dependent non-linearity of the sensitivity σ of the pressure sensor 1P, a temperature correction TC is determined before the actual measurement of the pressure P. For this purpose, FIG. 10 shows a horizontal, linear curve L with true pressure values, which do not exhibit any temperature-dependent non-linearity of the sensitivity σ and indicate the pressure P to be measured without falsification. The temperature correction TC is the difference between the non-linear curve of the sensitivity σ and the horizontal, linear curve L. The temperature correction TC can be obtained from a compensation calculation such as a regression analysis, etc. The temperature correction TC outputs a temperature correction value of the sensitivity σ for each temperature T.

Later, during the actual measurement of pressure P by pressure sensor 1P, the measurement of pressure P by pressure sensor 1P is combined with the measurement of temperature T by temperature sensor 1T. According to the following description, a temperature correction value TC corresponding to the measured temperature T is identified and taken into account to correct the temperature-dependent non-linearity of the sensitivity σ in the measured value of the pressure sensor 1P.

### The Temperature Sensor 1T

The sensor device 1 comprises at least one electrical conductor 40. Said electrical conductor 40 is configured to perform the function of generating a change in resistance ΔR for the temperature T to be measured.

Preferably, said electrical conductor 40 is carried on the front side of the base body 10. Preferably, the electrical conductor 40 is carried near but nonetheless spaced apart from the base body diaphragm 11. The electrical conductor 40 is arranged on the base body 10 by means of chemical vapor deposition, physical vapor deposition, and the like.

The electrical conductor 40 consists of electrically conductive material M40 such as Ni, Pt, Ti, and the like and desirably can be created and put in place by any standard process such as chemical vapor deposition, physical vapor deposition or lithography.

As schematically shown in FIGS. 4, 7, 8 and 12 for example, the electrical conductor 40 is applied to the base body 10 as a meandering line of conductive material configured with a thickness of 0.10 to 10 μm, a width of 2 to 20 μm, and a surface area of less than or equal to 1mm². The electrical resistance of the electrical conductor 40 is several kΩ. The temperature T to be measured causes a change in resistance ΔR of the electrical conductor 40, which change in resistance ΔR is proportional to the value of the measured temperature T.

The sensor device 1 comprises a plurality of conductor contact points 42, 44. The conductor contact points 42, 44 are configured to perform the function of providing electrical contact between the electrical conductor 40 and the transmission device 5 and an electrical power supply 41.

The conductor contact points 42, 44 consist of electrically conductive material such as Ag, Au, Pt, and the like and desirably can be created and put in place by any standard process such as chemical vapor deposition, physical vapor deposition or lithography.

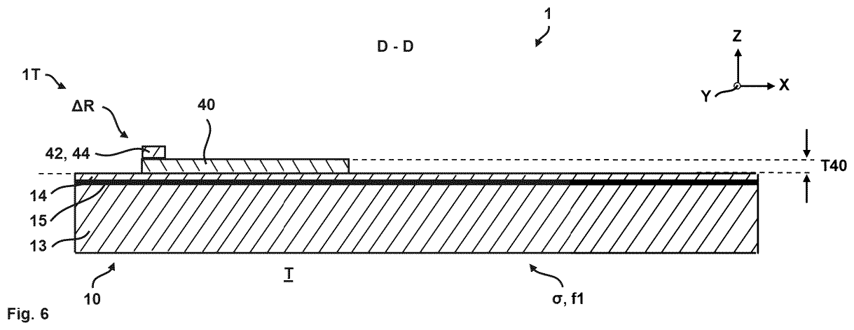

The conductor contact points 42, 44 comprise a first conductor contact point 42 and a second conductor contact point 42. The first conductor contact point 42 is arranged at a first end of the electrical conductor 40 and establishes an electrical contact with the first end of the electrical conductor 40. The second conductor contact point 44 is arranged at a second end of the electrical conductor 40 and establishes an electrical contact with the second end of the electrical conductor 40. As schematically shown in FIGS. 3 and 6 for example, each of the two conductor contact points 42, 44 has a flat extension parallel to the horizontal plane XY, which is designed to be large enough to achieve electrical contact such as thermosonic ball-wedge bonding, ultrasonic wedge-wedge bonding, etc.

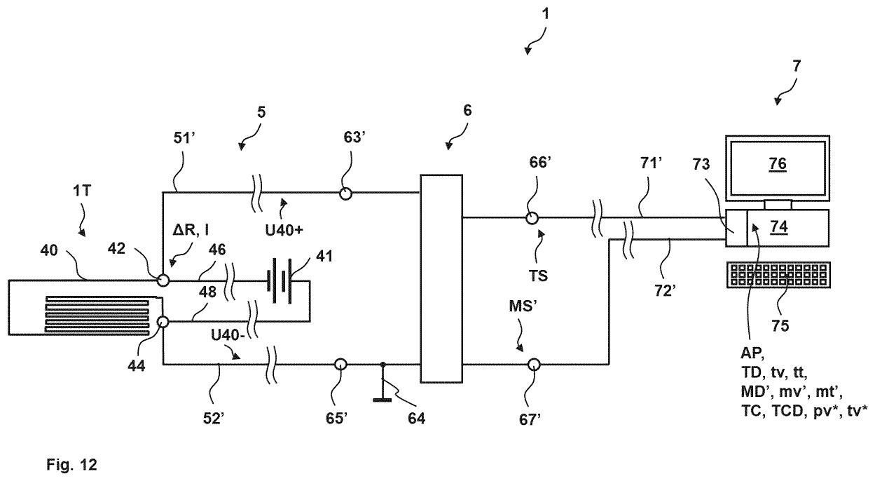

As schematically shown in FIG. 12 for example, the sensor device 1 comprises at least one electrical power supply 41. The electrical power supply 41 is configured to perform the function of generating a measured value for the resistance change ΔR of the electrical conductor 40.

For this purpose, the electrical power supply 41 comprises a direct current source, which is configured to generate an electrical direct current I, and a plurality of power supply conductors 46, 48 made of electrically conductive material such as Ag, Au, and the like and desirably can be created and put in place by any standard process such as chemical vapor deposition, physical vapor deposition or lithography. The power supply conductors 46, 48 comprise a first power supply conductor 46 and a second power supply conductor 48. According to the schematic circuit diagram shown in FIG. 12, an electrical contact is established with the first power supply conductor 46 at the first conductor contact point 42, and an electrical contact is established with the second power supply conductor 48 at the second conductor contact point 44. The two power supply conductors 46, 48 are wires with a diameter typically ranging from 15 to 200 μm. Thus, the direct current I from the direct current source flows through the electrical conductor 40. The magnitude of the direct current I is in the range from 1.0 μA to 10 μA. According to Ohm's law, the change in resistance ΔR and the applied electric current I result in an electric voltage U40+, U40−. The magnitude of the electric voltage U40+, U40− corresponds to the change in resistance ΔR and is therefore also proportional to the value of the measured temperature T. The electrical voltage U40+, U40− comprises a first electrical voltage U40+ at the first end of the electrical conductor 40 and a second electrical voltage U40− at the second end of the electrical conductor 40. The first electrical voltage U40+ is applied to the first conductor contact point 42. The second electrical voltage U40− is applied to the second conductor contact point 44. According to the following description, the first electrical voltage U40+ is preferably converted into a temperature signal TS, while the second electrical voltage U40− is preferably used as a second ground potential signal MS′.

The base body 10, the electrical conductor 40 arranged on the base body 10, and the electrical power supply 41 are configured to act in concert to form the temperature sensor 1T. The electrical voltage U40+, U40− is the measured value of the temperature sensor 1T. The magnitude of the electrical voltage U40+, U40− corresponds to the temperature T to be measured with respect to a reference temperature. The continuous operating temperature of the temperature sensor 1T is in the range from −40° C. to +800° C. The sensitivity of the temperature sensor 1T for the temperature T is in the range from 5.0 microvolts per degree Celsius (μV/° C.) to 9.0 μV/° C.

Advantageously, as schematically shown in FIG. 5, the temperature sensor 1T is located at a second horizontal distance DXY′ of less than or equal to 2 mm from the pressure sensor 1P. This small second horizontal distance DXY′ ensures that the temperature T measured by the temperature sensor 1T is equal to the temperature T acting on the pressure sensor 1P.

### The Compensator 1K

According to the second and fourth embodiments, the sensor device 1 comprises a plurality of compensator electrodes 31, 33. Said compensator electrodes 31, 33 are configured to perform the function of tapping the pyroelectric charge P30+, P30− from the surfaces of the compensator material 30. The first sensor electrode 21 taps the first pyroelectric charge P20+, and the second sensor electrode 23 taps the second pyroelectric charge P20−.

The compensator electrodes 31, 33 are arranged in the region of the surfaces of the compensator material 30 where pyroelectric charge P30+, P30− is generated. The compensator electrodes 31, 33 comprise a first compensator electrode 31 and a second compensator electrode 33. The compensator electrodes 31, 33 are made of electrically conductive material such as Ag, Au, Pt, and the like, and they are made and put in place just like the sensor electrodes 21, 23 as described herein.

In the cross-section view of FIG. 5, the first compensator electrode 31 lies against the surface of the compensator material 30 facing away from the base body 10 and configured to tap the first pyroelectric charge P30+. The second compensator electrode 33 lies against the surface of the compensator material 30 facing the base body 10 and configured to tap the second piezoelectric charge P30−. Each of the two compensator electrodes 31, 33 forms a layer extending parallel to the horizontal plane XY. Along the vertical axis Z, each of the two compensator electrodes 31, 33 desirably is defined by a constant thickness of less than or equal to 200 nm.

In said Regarding the generation of charge by the sensor material 20, each of the sensor electrodes 21, 23 is configured to tap the pyroelectric charge P20+, P20− together with the piezoelectric charge Q20+, Q20− generated by the sensor material 20.

Preferably, said sensor electrodes 21, 23 and the compensator electrodes 31, 33 are configured with an identical structure. Preferably, the size and shape of the area of the sensor electrodes 21, 23 is equal to the size and shape of the area of the compensator electrodes 31, 33. Preferably, the ratio of the size of the area of the sensor electrodes 21, 23 to the size of the area of the compensator electrodes 31, 33 is known.

According to the second and fourth embodiments, the sensor device 1 comprises a plurality of compensator contact points 32, 34. The compensator contact points 32, 34 are configured to perform the function of providing electrical contact between the compensator electrodes 31, 33 and the transmission device 5.

The compensator contact points 32, 34 consist of electrically conductive material such as Ag, Au, Pt, and the like, just like the sensor contact points 22, 24, and they are made and put in place just like the sensor contact points 22, 24, as described herein.

The compensator contact points 32, 34 comprise a first compensator contact point 32 and a second compensator contact point 34. As schematically shown in FIG. 5, the first compensator contact point 32 lies against the first compensator electrode 31 and establishes an electrical contact with the first compensator electrode 31. The second compensator contact point 34 lies against the second compensator electrode 33 and establishes an electrical contact with the second compensator electrode 33. Each of the two compensator contact points 32, 34 defines a planar extension parallel to the horizontal plane XY, which is designed to be large enough to accomplish electrical contacting such as thermosonic ball-wedge bonding, ultrasonic wedge-wedge bonding, and the like.

The region of the base body 10 in which the compensator material 30 is located, the compensator material 30 carried by the base body 10 and the compensator electrodes 31, 33 arranged on the surfaces of the compensator material 30 are configured to act in concert to form the compensator 1K of the embodiments of the sensor device 1 as shown in FIGS. 1 to 3. The compensator 1K desirably is configured for a permanent operating temperature in the range from −40° C. to +500° C.

Advantageously, as schematically shown in FIG. 5, said compensator 1K is arranged at a first horizontal distance DXY of less than or equal to 2 mm from the pressure sensor 1P. This small first horizontal distance DXY ensures that the temperature change ΔT acts equally on the sensor material 20 of the pressure sensor 1P and on the compensator material 30 of the compensator 1K and generates the same amount of pyroelectric charge P20+, P20− in the sensor material 20 and pyroelectric charge P30+, P30− in the compensator material 30.

Advantageously, said sensor material 20 generates a plurality of piezoelectric charges Q20+, Q20− under the effect of the pressure P and a plurality of pyroelectric charges P20+, P20− under the effect of the temperature change ΔT. For a measuring frequency f* of at most ⅓ of the natural frequency f1 of greater than or equal to 1 MHz, the plurality of piezoelectric charges Q20+, Q20− of the sensor material 20 is configured to be generated at a rate of 106 piezoelectric charges Q20+, Q20− per second, and the plurality of pyroelectric charges K20+, K20− of the sensor material 20 is configured to be generated at a rate of 106 pyroelectric charges P20+, P20− per second. The compensator material 30 is configured to generate a large number of pyroelectric charges P30+, P30− under the effect of the temperature change ΔT. For a measuring frequency f* of at most ⅓ of the natural frequency f1 of greater than or equal to 1 MHz, the plurality of pyroelectric charges P30+, P30− of the compensator material 30 is configured to be generated at a rate of 106 pyroelectric charges P30+, P30− per second. Thus, for each pyroelectric charge P20+, P20− generated by the sensor material 20, there is a time-corresponding pyroelectric charge P30+, P30− generated by the compensator material 30.

### The Group of Pressure Sensors 1P

According to the third and fourth embodiment of the sensor device 1, said base body 10 comprises a plurality of base body diaphragms 11, which are configured as describe above.

Preferably, the plurality of base body diaphragms 11 is carried on the front side of the base body 10 and disposed to lie parallel to the horizontal plane XY. The pressure P to be measured acts along the vertical direction Z on the front surfaces F11 of the plurality of base body diaphragms 11 and deflects the plurality of base body diaphragms 11. On each of the plurality of base body diaphragms 11, said sensor material 20 is arranged in at least one area overlying the front surface F11 of the base body diaphragm 11. The sensor material 20 is configured to generate piezoelectric charge Q20+, Q20− as a result of the deflection of each said base body diaphragm 11 constituting the plurality of base body diaphragms 11 in the third and fourth embodiments of the sensor device. On each of the plurality of base body diaphragms 11, the first sensor electrode 21 is arranged on the surface of the sensor material 20 facing away from the base body diaphragm 11 and configured to tap the first piezoelectric charge Q20+. The second sensor electrode 23 is arranged on the surface of the sensor material 20 facing the base body diaphragm 11 and configured to tap the second piezoelectric charge Q20−.

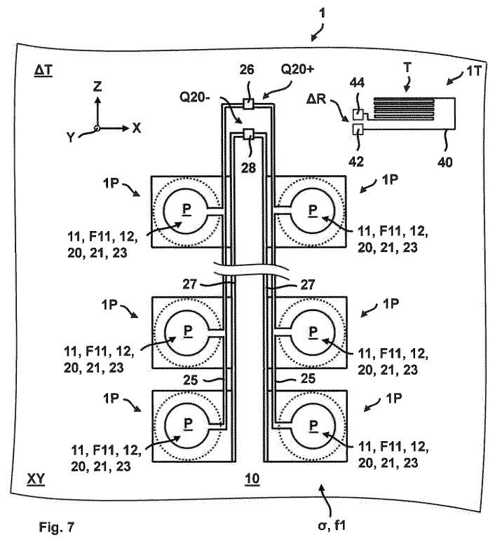

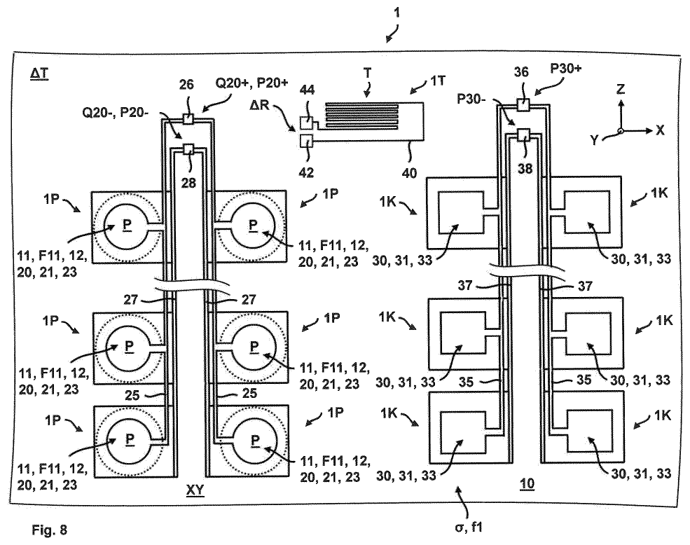

According to the third and fourth embodiments, the sensor device 1 comprises a plurality of sensor group conductors 25, 27. As schematically shown in FIGS. 7 and 8, the sensor group conductors 25, 27 are configured to perform the function of collecting the piezoelectric charge Q20+, Q20− generated by the sensor material 20 of each of the plurality of base body diaphragms 11.

The sensor group conductors 25, 27 consist of electrically conductive material such as Ag, Au, Pt, and the like and desirably can be created and put in place by any standard process such as chemical vapor deposition, physical vapor deposition or lithography. The sensor group conductors 25, 27 are arranged in the regions of the two surfaces of the sensor material 20. The sensor group conductors 25, 27 comprise a first sensor group conductor 25 and a second sensor group conductor 27. As schematically shown in FIGS. 7 and 8, the first sensor group conductor 25 is configured and disposed to provide an electrical contact with the first sensor electrodes 21 and electrically connects them in series. Similarly, the second sensor group conductor 27 is configured and disposed to provide an electrical contact with the second sensor electrodes 23 and electrically connects them in series. The plurality of base body diaphragms 11 on which sensor material 20 is carried on front surfaces F11, the sensor material 20 carried on the plurality of base body diaphragms 11 and the sensor electrodes 21, 23 and sensor group conductors 25, 27 electrically connecting the surfaces of this sensor material 20 in series are configured to act in concert to form a group of pressure sensors 1P. Advantageously, the base body 10 is configured with a plurality of greater than or equal to two base body diaphragms 11, preferably a plurality of greater than or equal to sixteen base body diaphragms 11, preferably a plurality of greater than or equal to 128 base body diaphragms 11. The increase in the natural frequency f1 of the sensor device 1 according to the invention is achieved by a decrease in the ratio of thickness T11 to diameter D11 of the base body diaphragm 11, but the sensitivity σ of the sensor device 1 according to the invention decreases as well. The sensitivity σ changes quadratically with the diameter D11 of the base body diaphragm 11. If the thickness T11 is kept constant, halving the diameter D11 of the base body diaphragm 11 results in a quartering of the magnitude of piezoelectric charge Q20+, Q20− generated. By arranging a plurality of base body diaphragms 11 in the base body 10, with sensor material 20 being mechanically coupled to each front surface F11 of the plurality of base body diaphragms 11, and the series connection of the sensor electrodes 21, 23, which tap the piezoelectric charge Q20+, Q20− of the sensor material 20, the decrease in sensitivity σ of the sensor device 1 according to the invention can be compensated for and even increased.

According to the third and fourth embodiments, the sensor device 1 comprises a plurality of sensor group contact points 26, 28. As schematically shown in FIGS. 7 and 8, said sensor group contact points 26, 28 are configured to perform the function of providing an electrical contact with the transmission device 5 schematically shown in FIGS. 11-14.

The sensor group contact points 26, 28 are made of electrically conductive material such as Ag, Au, and the like and desirably can be created and put in place by any standard process such as chemical vapor deposition, physical vapor deposition or lithography. The sensor group contact points 26, 28 comprise a first sensor group contact point 26 and a second sensor group contact point 28. The first sensor group contact point 26 is configured and disposed in an electrical connection to the first sensor group conductor 25. The second sensor group contact point 28 is configured and disposed in an electrical connection to the second sensor group conductor 27. Each of the two sensor group contact points 26, 28 is configured to define a flat extension parallel to the horizontal plane XY, and configured to be large enough to enable electrical contact such as thermosonic ball-wedge bonding, ultrasonic wedge-wedge bonding, and the like.

### The Group of Compensators 1K

According to the fourth embodiment, said sensor device 1 comprises a base body 10 with a plurality of regions carrying compensator material 30. Preferably, as schematically shown in FIG. 5 for example, the plurality of regions with compensator material 30 is arranged on the front side of the base body 10. As described above, both the compensator material 30 and the sensor material 20 are preferably made of the same CGS, LGS, tourmaline, AlN, PZT, and the like with pyroelectric effect.

The regions comprising compensator material 30 are spaced apart from each other and thus electrically insulated to each other by the electrically insulating material of said base body 10. Preferably, the plurality of regions with compensator material 30 is arranged spaced apart from the plurality of base body diaphragms 11. Thus, the regions with compensator material 30 are also electrically insulated from the sensor material 20 mechanically coupled to the plurality of base body diaphragms 11 by the electrically insulating material of the base body 1.

Since the plurality of regions with compensator material 30 is arranged spaced apart from the plurality of base body diaphragms 11, the pressure P to be measured cannot be sensed on the plurality of regions with compensator material 30, because the base body 10 does not experience any deflection due to the action of the pressure P and thus the plurality of regions with compensator material 30 does not generate a piezoelectric charge as a measured value.

A temperature change ΔT equally acts on the sensor material 20 mechanically coupled to the plurality of base body diaphragms 11 and on the plurality of regions with compensator material 30 and generates pyroelectric charge P20+, P20− in both the sensor material 20 and pyroelectric charge P30+, P30− in said compensator material 30. Preferably, said sensor material 20 and the compensator material 30 are configured with an identical structure, so that the magnitude of pyroelectric charge P20+, P20− generated in the sensor material 20 is equal to the magnitude of pyroelectric charge P30+, P30− generated in the compensator material 30.

As schematically shown in FIGS. 2 and 5 for example, on each of the plurality of base body diaphragms 11, the first sensor electrode 21 is configured to lie on the surface of the sensor material 20 facing away from the base body diaphragm 11 and tap first pyroelectric charge P20+. Said second sensor electrode 23 is configured to lie on the surface of the sensor material 20 facing the base body diaphragm 11 and tap the second pyroelectric charge P20−. As schematically shown in FIG. 5 for example, on each of the plurality of regions with compensator material 30, the first compensator electrode 31 is configured to lie on the surface of the compensator material 30 facing away from the base body 10 and tap first pyroelectric charge P30+. The second compensator electrode 33 is configured to lie on the surface of the compensator material 30 facing the base body 10 and tap the second pyroelectric charge P30−.

As schematically shown in FIG. 8 for example, said sensor device 1 comprises a plurality of compensator group conductors 35, 37. The compensator group conductors 35, 37 are configured to perform the function of collecting the pyroelectric charge P30+, P30−.

The compensator group conductors 35, 37 consist of electrically conductive material such as Ag, Au, Pt, and the like and desirably can be created and put in place by any standard process such as chemical vapor deposition, physical vapor deposition or lithography.

The compensator group conductors 35, 37 are arranged in the region of the two surfaces of the compensator material 30. The compensator group conductors 35, 37 comprise a first compensator group conductor 35 and a second compensator group conductor 37. The first compensator group conductor 35 is configured to provide an electrical contact with the first compensator electrodes 31 and electrically connects them in series. The second compensator group conductor 37 is configured to provide an electrical contact with the second compensator electrodes 33 and electrically connects them in series.

The regions of the base body 10 on which the plurality of regions with compensator material 30 are arranged mechanically coupled, the plurality of regions with compensator material 30, and the compensator electrodes 31, 33 and compensator group conductors 35, 37 arranged on the surfaces of these regions with compensator material 30 are configured to act in concert to form a group of compensators 1K.

As schematically shown in FIG. 8 for example, said sensor device 1 comprises a plurality of compensator group contact points 36, 38. The compensator group contact points 36, 38 are configured to perform the function of providing an electrical contact with the transmission device 5.

The compensator group contact points 36, 38 consist of electrically conductive material such as Ag, Au, Pt, and the like and desirably can be created and put in place by any standard process such as chemical vapor deposition, physical vapor deposition or lithography.

The compensator group contact points 36, 38 comprise a first compensator group contact point 36 and a second compensator group contact point 38. The first compensator group contact point 36 is arranged on and electrically connected to the first compensator group conductor 35 and establishes an electrical contact with it. The second compensator group contact point 38 is arranged on and electrically connected to the second compensator group conductor 37 and establishes an electrical contact with it. Each of the two compensator group contact points 36, 38 is configured to define a planar extension parallel to the horizontal plane XY and defines a footprint area large enough to accomplish electrical contacting such as thermosonic ball-wedge bonding, ultrasonic wedge-wedge bonding, and the like.

### The Transmission Device 5

The transmission device 5 is configured to perform the function of transmitting the piezoelectric charge Q20+, Q20− and the electrical voltage U40+, U40−. The transmission device 5 comprises a plurality of charge transmitters 51, 51′, 52, 52′ made of electrically conductive material such as copper (Cu), Ag, Au, and the like and desirably can be created and put in place by any standard process such as chemical vapor deposition, physical vapor deposition or lithography. The charge transmitters 51, 52 desirably are wires typically 15 to 200 μm in diameter.

The charge transmitters 51, 51′, 52, 52′ comprise a first charge transmitter 51, a second charge transmitter 52, a first voltage transmitter 51′, and a second voltage transmitter 52′.

According to the schematic circuit diagram shown in FIG. 11, the first charge transmitter 51 electrically contacts the first sensor contact point 22, and the second charge transmitter 52 electrically contacts the second sensor contact point 24. The voltage transmitters 51, 52 are configured to transmit the electrical charge Q20+, Q20− from the two sensor contact points 22, 24.

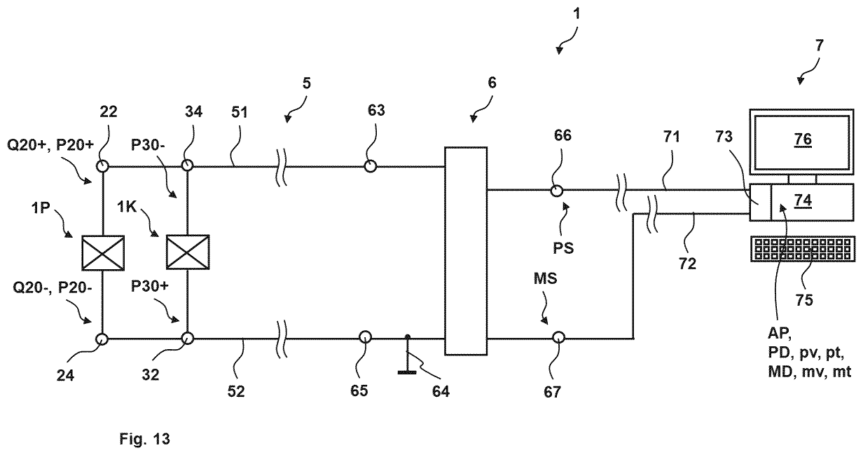

According to the schematic circuit diagram shown in FIG. 12, the first voltage transmitter 51′ electrically contacts the first conductor contact point 42, and the second voltage transmitter 52′ electrically contacts the second conductor contact point 44. The voltage transmitters 51′, 52′ are configured to transmit the electrical voltage U40+, U40− from the two conductor contact points 42, 44. According to the schematic circuit diagram shown in FIG. 13, the first charge transmitter 51 is configured to provide an electrical contact with the first sensor electrode 21 via the first sensor contact point 22 and establishes an electrical contact with the second compensator electrode 33 via the second compensator contact point 34. Thus, the first charge transmitter 51 is configured to carry the first piezoelectric charge Q20+ and the first pyroelectric charge P20+ of the sensor material 20 and the second pyroelectric charge P30− of the compensator material 30. Advantageously, the magnitude of the first pyroelectric charge P20+ of the sensor material 20 is equal to the magnitude of the second pyroelectric charge P30− of the compensator material 30, so that the pyroelectric charges P20+, P30− at the first charge transmitter 51 electrically cancel and thus compensate each other.

According to the schematic circuit diagram shown in FIG. 13, the second charge transmitter 52 is configured to provide an electrical contact with the second sensor electrode 23 via the second sensor contact point 24 and establishes an electrical contact with the first compensator electrode 31 via the first compensator contact point 32. Thus, the second charge conductor 52 is configured to carry the second piezoelectric charge Q20− and the second pyroelectric charge P20− of the sensor material 20 and the first pyroelectric charge P30+ of the compensator material 30. Advantageously, the magnitude of the second pyroelectric charge P20− of the sensor material 20 is equal to the magnitude of the first pyroelectric charge P30+ of the compensator material 30, so that the pyroelectric charges P20−, P30+ at the second charge transmitter 52 electrically cancel and thus compensate each other.

The charge transmitters 51, 52 are configured to transmit the piezoelectric charge Q20+, Q20− from the sensor contact points 22, 24.

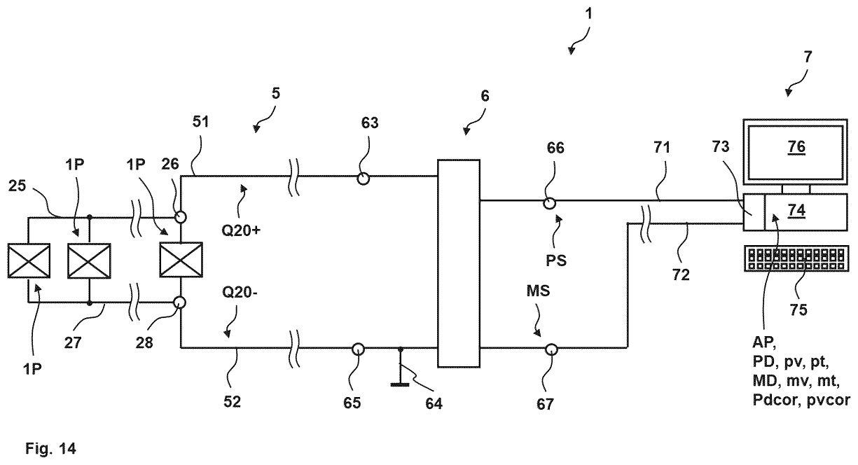

According to the schematic circuit diagram shown in FIG. 14, the first charge transmitter 51 contacts the first sensor group contact point 26, and the second charge transmitter 52 contacts the second sensor group contact point 28. The electrical charge Q20+, Q20− is discharged from the two sensor group contact points 26, 28 via these charge transmitters 51, 52.

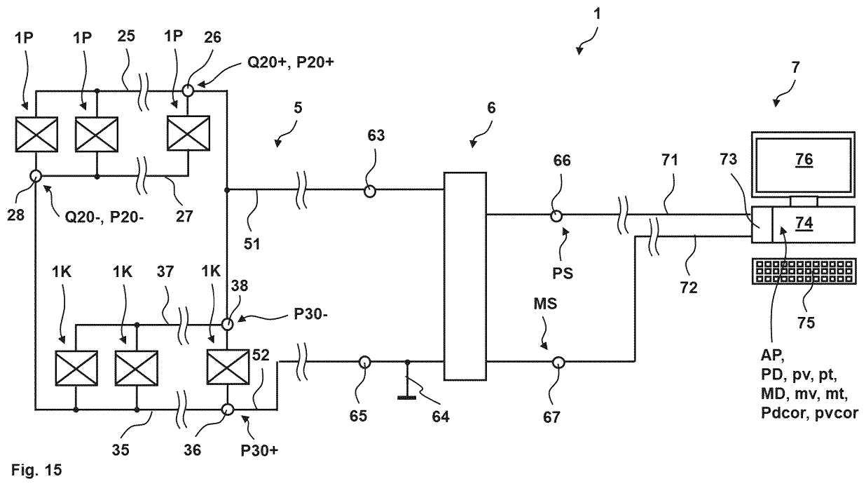

According to the schematic circuit diagram shown in FIG. 15, the first charge transmitter 51 is configured to provide an electrical contact with the first sensor group contact point 26 and with the second compensator group contact point 38. Thus, the first charge conductor 51 is configured to carry the first piezoelectric charge Q20+ and the first pyroelectric charge P20+ of the sensor material 20 and the second pyroelectric charge P30− of the compensator material 30. Advantageously, the magnitude of the first pyroelectric charge P20+ of the sensor material 20 is equal to the magnitude of the second pyroelectric charge P30− of the compensator material 30, so that the pyroelectric charges P20+, P30− at the first charge transmitter 51 electrically cancel and thus compensate each other.

According to the schematic circuit diagram shown in FIG. 15, the second charge transmitter 52 is configured to provide an electrical contact with the second sensor group contact point 28 and with the first compensator group contact point 36. Thus, the second charge conductor 52 is configured to carry the second piezoelectric charge Q20− and the second pyroelectric charge P20− of the sensor material 20 and the first pyroelectric charge P30+ of the compensator material 30. Advantageously, the magnitude of the second pyroelectric charge P20− of the sensor material 20 is equal to the magnitude of the first pyroelectric charge P30+ of the compensator material 30, so that the pyroelectric charges P20−, P30+ at the second charge transmitter 52 electrically cancel and thus compensate each other.

### The Transducer Unit 6

The transducer unit 6 is configured to perform the function of electrically transducing transmitted piezoelectric charge Q20+, Q20− into at least one pressure signal PS and at least one first ground potential signal MS, and transducing electrical voltage U40+, U40− into at least one temperature signal TS and at least one second ground potential signal MS′.

According to the schematic circuit diagrams shown in FIGS. 11 to 15, said transducer unit 6 comprises at least one first charge input contact 63, at least one second charge input contact 65, at least one first voltage input contact 63′, at least one second voltage input contact 65′, at least one ground potential 64, at least one first signal output contact 66, at least one second signal output contact 66′, at least one first ground potential output contact 67, and at least one second ground potential output contact 67′.

The charge input contacts 63, 65 are configured to perform the function of providing an electrical contact between the transducer unit 6 and the transmission device 5. The charge input contacts 63, 65 consist of electrically conductive material such as Cu, Ag, Au, and the like and desirably can be created and put in place by any standard process such as chemical vapor deposition, physical vapor deposition or lithography.

The first charge transmitter 51 is configured to provide an electrical contact with the first charge input contact 63. Thus, the first piezoelectric charge Q20+ of the pressure sensor 1P and the group of pressure sensors 1P are connected electrically to the transducer unit 6.

The second charge transmitter 52 is configured to provide an electrical contact with the ground potential 64 via the second charge input contact 65. Thus, the second piezoelectric charge Q20− of the pressure sensor 1P and the group of pressure sensors 1P are electrically connected at the ground potential 64.

The first voltage transmitter 51′ is configured to provide an electrical contact with the first voltage input contact 63′. Thus, the first electrical voltage U40+ of the temperature sensor 1T is applied to the transducer unit 6.

The second voltage transmitter 52′ is configured to provide an electrical contact with the ground potential 64 via the second voltage input contact 65′. Thus, the second electrical voltage U40− of the temperature sensor 1T is electrically connected at the ground potential 64.

The transducer unit 6 transduces the first piezoelectric charge Q20+ into an electrically amplified electrical output voltage. The pressure signal PS is the electrical output voltage. The pressure signal PS is proportional to the value of the measured pressure P. Each first piezoelectric charge Q20+ is transduced by the transducer unit 6 into a pressure signal PS.

The transducer unit 6 is configured to transduce the second piezoelectric charge Q20− into an electrical output voltage. The first ground potential signal MS is the electrical output voltage. The transducer unit 6 is configured to transduce every second piezoelectric charge Q20− into a first ground potential signal MS.

The transducer unit 6 is configured to transduce the first electrical voltage U40+ into an electrically amplified output voltage. The temperature signal TS is the electrical output voltage. The temperature signal TS is proportional to the value of the measured temperature T. The transducer unit 6 is configured to transduce every first electrical voltage U40+ into a temperature signal TS.

The transducer unit 6 is configured to transduce the second electrical voltage U40− into an electrical output voltage. The second ground potential signal MS′ is the electrical output voltage. The transducer unit 6 is configured to transduce every second electrical voltage U40− into a second ground potential signal MS′.

The signal output contact 66, 66′ and the ground potential output contact 67, 67′ are configured to perform the function of providing an electrical contact between the transducer unit 6 and the evaluation unit 7. The signal output contact 66, 66′ and the ground potential output contact 67, 67′ are made of electrically conductive material such as Cu, Ag, Au, and the like and desirably can be created and put in place by any standard process such as chemical vapor deposition, physical vapor deposition or lithography.

The pressure signal PS is applied to the first signal output contact 66. The first ground potential output contact 67 is configured to provide an electrical contact with the ground potential 64. The first ground potential signal MS is applied to the first ground potential output contact 67.

The temperature signal TS is applied to the second signal output contact 66′. The second ground potential output contact 67′ is configured to provide an electrical contact with the ground potential 64. The second ground potential signal MS′ is applied to the second ground potential output contact 67′.

### The Evaluation Unit 7

The evaluation unit 7 is configured to perform the function of evaluating the pressure signal PS, the first ground potential signal MS, the temperature signal TS, and the second ground potential signal MS′.

For this purpose, as schematically shown in FIGS. 11-15, the evaluation unit 7 comprises at least one first signal conductor 71, at least one second signal conductor 71′, at least one first ground potential conductor 72, at least one second ground potential conductor 72′, at least one interface 73, at least one computing unit 74, at least one input unit 75, and at least one output unit 76.

The signal conductor 71, 71′ and the ground potential conductor 72, 72′ are made of electrically conductive material such as Cu, Ag, Au, and the like and desirably can be created and put in place by any standard process such as chemical vapor deposition, physical vapor deposition or lithography.

An electrical contact is established with the first signal conductor 71 at the first signal output contact 66, and an electrical contact is established with the first ground potential conductor 72 at the first ground potential output contact 67. The first signal conductor 71 is configured to transmit the pressure signal PS to the interface 73. The first ground potential conductor 72 is configured to transmit the first ground potential signal MS to the interface 73.

An electrical contact is established with the second signal conductor 71′ at the second signal output contact 66′, and an electrical contact is established with the second ground potential conductor 72′ at the second ground potential output contact 67′. The second signal conductor 71′ is configured to transmit the temperature signal TS to the interface 73. The second ground potential conductor 72′ is configured to transmit the second ground potential signal MS′ to the interface 73.

The interface 73 is configured to perform the function of digitizing the pressure signal PS, the first ground potential signal MS, the temperature signal TS, and the second ground potential signal MS′ into digital pressure data elements PD, digital temperature data elements TD, digital first ground potential data elements MD, and digital second ground potential data elements MD′.

For this digitizing purpose, said interface 73 comprises at least one transducer element such as an analog-to-digital transducer, and the like. The transducer element is designed to digitize the pressure signal PS, the first ground potential signal MS, the temperature signal TS, and the second ground potential signal MS′ into digital pressure data elements PD, digital temperature data elements TD, digital first ground potential data elements MD, and digital second ground potential data elements MD′. Each digital pressure data element PD, digital temperature data element TD, digital first ground potential data element MD, and digital second ground potential data element MD′ is a binary number sequence with a resolution of 12 bits, 16 bits, and the like.

The interface 73 also comprises at least one timer, such as a clock, and the like. The timer is configured to provide each digital pressure data element PD with a pressure time point pt, each digital temperature data element TD with a temperature time point tt, each digital first mass potential data element MD with a first ground potential time point mt, and each digital second ground potential data element MD′ with a second mass potential time point mt'. Each pressure time point pt, temperature time point tt, first ground potential time point mt, and second ground potential time point mt is a binary number sequence with a resolution of 12 bits, 16 bits, and the like. Each pressure time point pt, temperature time point tt, first ground potential time point mt, and second ground potential time point mt has a temporal resolution which, according to the Nyquist-Shannon sampling theorem, is equal to the reciprocal of twice the measuring frequency f*. For a measuring frequency f* of at most ⅓ of the natural frequency f1 greater than or equal to 1 MHz, the time point pt, mt has a temporal resolution greater than or equal to 3/2 10⁻⁶ sec.

Each digital pressure data element PD includes a pressure value pv and a pressure time point pt, which pressure time point pt is associated with the digital pressure data element PD. The interface 73 is configured to digitize each pressure signal PS into a digital pressure data element PD with a pressure value pv and provides the digital pressure data element PD with an associated pressure time point pt.

Each temperature data element TD includes a temperature value tv and a temperature time point tt, which temperature time point tt is associated with the digital temperature data element TD. Said interface 73 is configured to digitize each temperature signal TS into a digital temperature data element TD with a temperature value tv and provides the digital temperature data element TD with an associated temperature time point tt.

Every digital first ground potential data element MD includes a first ground potential value mv and a first ground potential time point mt, which first ground potential time point mt is associated with the digital first ground potential data element MD. Said interface 73 is configured to digitize every first ground potential signal MS into a digital first ground potential data element MD with a first ground potential value mv and provides the digital first ground potential data element MD with an associated first ground potential time point mt.

Every digital second ground potential data element MD′ includes a second ground potential value mv′ and a second ground potential time point mt′, which second ground potential time point mt′ is associated with the digital second ground potential data element MD′. Said interface 73 is configured to digitize every digital second ground potential signal MS′ into a second ground potential data element MD′ with a second ground potential value mv′ and provides the digital second ground potential data element MD′ with an associated second ground potential time point mt′.

The computing unit 74 comprises at least one data storage device and at least one data processor.

Said computing unit 74 comprises at least one evaluation program AP, which is stored in the data memory and which can be loaded into the data processor to be operated. The evaluation program AP loaded into the data processor is designed to evaluate the digital pressure data elements PD, digital temperature data elements TD, digital first ground potential data elements MD, and digital second ground potential data elements MD′.

The evaluation is configured to be operated by the data processor to provide a correction of the temperature-dependent non-linearity of the sensitivity σ of the pressure sensor 1P in at least one pressure data element PD.

To this end, the data processor is configured to operate the evaluation program AP to read in the pressure time points pt and temperature time points tt associated with the pressure data elements PD and the temperature data elements TD.

Now, said evaluation program AP is configured to compare the pressure time points pt and the temperature time points tt with each other. The evaluation program AP is configured to combine a pressure data element PD, whose associated pressure time point pt is equal to the temperature time tt associated with the temperature data element TD, with this temperature data element TD.

A temperature correction TC with a plurality of temperature correction data elements TCD is stored in the data memory. Preferably, the temperature correction TC has temperature correction data elements TCD over the entire range of the permanent operating temperature of the sensor material 20 from −40° C. to +500° C. Each temperature correction data element TCD has a further pressure value pv* and a further temperature value tv* assigned to the further pressure value pv*. The further pressure value pv* is the correction value by which the pressure value pv of the pressure data element PD at a temperature T deviates from the true pressure value due to the temperature-dependent non-linearity of the sensitivity σ of the pressure sensor 1P. Preferably, the temperature correction TC has a resolution of the temperature T of less than or equal to 0.1° C. Preferably, the temperature correction TC has a plurality of more than 106 temperature correction data elements TCD.

The data processor is configured to operate the evaluation program AP to read at least one temperature correction data element TCD from the data memory. The evaluation program AP is configured to identify a temperature correction data element TCD whose associated further temperature value tv* is equal to the temperature value tv of the combined temperature data element TD (tv*=tv).

Now, said evaluation program AP is configured to subtract the further pressure value pv* of the identified temperature correction data element TCD from the pressure value pv of the pressure data element PD which is combined therewith. The result of the subtraction is a temperature-corrected pressure value pvcor. The subtraction corrects the temperature-dependent non-linearity of the sensitivity σ in the pressure value pv of the pressure data element PD. The measurement data element with the temperature-corrected pressure value pvcor is called the temperature-corrected pressure data element PDcor according to the following relation:

$$PDcor ( pvcor , {tv}^{*} = tv ) = PD ( pv , {tv}^{*} = tv ) - TCD ( {pv}^{*} , {tv}^{*} = tv )$$

The computing unit 74 is configured to be operated via the input unit 75. The verb “operate” means that a human person can enter commands via said input unit 75, which commands are executed by the computing unit 74. The input unit 75 can be a keyboard or a touch-sensitive screen for entering commands. Commands can be entered as character strings via the input unit 75, and the evaluation program AP loaded into the data processor is designed to generate control data for the commands entered. Thus, the command entered may be to switch the operational status, i.e., on or off, of said sensor device 1, and the evaluation program AP loaded into the data processor is designed to generate control data for the command, which control data switches on or off said sensor device 1. Also, the evaluation program AP loaded into the data processor is also configured to graphically display the pressure data elements PD, temperature data elements TD, first ground potential data elements MD, and second ground potential data elements MD′ for evaluation. The output unit 76 can be a screen on which the pressure data elements PD, temperature data elements TD, first mass potential data elements MD, and second mass potential data elements MD′ are graphically displayed for human beings. With knowledge of the present invention, a person skilled in the art can realize a wide variety of variations of the embodiments shown. Thus, for example, the pressure sensor 1P, the temperature sensor 1T, the compensator 1K, the transmission device 5, and the transducer unit 6 can be realized in a housing at the location where the pressure P and the temperature T are measured.

### LIST OF REFERENCE SYMBOLS

1 Sensor device
1P Pressure sensor
1K Compensator
1T Temperature sensor
5 Transmission device
6 Transducer unit
7 Evaluation unit
10 Base body
11 Base body diaphragm
D11 Diameter of base body diaphragm
F11 Front surface of the base body diaphragm
F12 Rear surface of the base body diaphragm
T11 Thickness of the base body diaphragm
12 Base body opening
13 Supporting layer
14 Boundary layer
15 Stop layer
20 Sensor material
D20 Base area of the sensor material
T20 Thickness of the sensor material
21 First sensor electrode
D21 Base area of the first sensor electrode
22 First sensor contact point
23 Second sensor electrode
D23 Base area of the second sensor electrode
24 Second sensor contact point
25 First sensor group conductor
26 First sensor group contact point
27 Second sensor group conductor
28 Second sensor group contact point
30 Compensator material
D30 Base area of the compensator material
T30 Thickness of the compensator material
31 First compensator electrode
32 First compensator contact point
33 Second compensator electrode
34 Second compensator contact point
35 First compensator group conductor
36 First compensator group contact point
37 Second compensator group conductor
38 Second compensator group contact point
40 Electrical conductor
T40 Thickness of the electrical conductor
41 Electrical power supply
42 First conductor contact point
44 Second conductor contact point
46 First power supply conductor
48 Second power supply conductor
51 First charge transmitter
51′ First voltage transmitter
52 Second charge transmitter
52′ Second voltage transmitter
63 First charge input contact
63′ First voltage input contact
64 Ground potential
65 Second charge input contact
65′ Second voltage input contact
66 First signal output contact
66′ Second signal output contact
67 First ground potential output contact
67′ Second ground potential output contact
71 First signal conductor
71′ Second signal conductor
72 First ground potential conductor
72′ Second ground potential conductor
73 Interface
74 Computing unit
75 Input unit
76 Output unit
AP Evaluation program
B-B Section path
B-B Section path
C-C Section path
D-D Section path
DXY First horizontal distance
DXY′ Second horizontal distance
ΔR Resistance change
f1 Natural frequency
f* Measuring frequency
I Electrical current
L Linear curve
MD First ground potential data element
MD′ Second ground potential data element
MS First ground potential signal
MS′ Second ground potential signal
mt First ground potential time point
mt′ Second ground potential time point
mv First ground potential value
mv′ Second ground potential value
P Pressure
P+− Pyroelectric charge
P20+ First pyroelectric charge
P20− Second pyroelectric charge
p30+ First pyroelectric charge
P30− Second pyroelectric charge
PD Pressure data element
PDcor Temperature-corrected pressure data element
PS Pressure signal
pt Pressure time point
pv Pressure value
pv* Further pressure value
pvcor Temperature-corrected pressure value
Q20+ First piezoelectric charge
Q20− Second piezoelectric charge
σ Sensitivity
T Temperature
TC Temperature correction
TCD Temperature correction data element
TS Temperature signal
tv Temperature value
tv* Further temperature value
tt Temperature time point
U40+, U40− Electrical voltage
X Horizontal axis
XY Horizontal plane
Y Transverse axis
Z Vertical axis

What is claimed is:

1. Sensor device designed to measure a pressure, the sensor device comprising:
a base body defining a base body diaphragm configured to sense the pressure to be measured by undergoing a deflection caused by the effect of the pressure;
a sensor material disposed on the base body diaphragm and configured to generate piezoelectric charge under the effect of the deflection of said base body diaphragm such that a magnitude of the generated piezoelectric charge is proportional to the value of the measured pressure;
an electrical conductor disposed on the base body;
wherein the electrical conductor is disposed so that the temperature to be measured causes a change in resistance of the electrical conductor, which change in resistance is proportional to the value of the measured temperature.

2. Sensor device according to claim 1, further comprising:
an electrical power supply configured to provide an electrical direct current through said electrical conductor; and
wherein an electrical voltage resulting from the change in resistance of the electrical conductor and the direct electrical current, and the magnitude of the electrical voltage is proportional to the value of the measured temperature.

3. Sensor device according to claim 1,
wherein the base body diaphragm defines a thickness measured along a vertical axis and a diameter measured in a horizontal plane perpendicular to the longitudinal axis;
wherein the thickness of the base body diaphragm is less than or equal to 20 μm;
wherein the diameter of said base body diaphragm is less than or equal to 300 μm; and
wherein a ratio of thickness to diameter of said base body diaphragm is configured in such a manner that the sensor device has a natural frequency of greater than or equal to 1 MHz.

4. Sensor device according to claim 1, wherein the electrical conductor is arranged outside the base body diaphragm.

5. Sensor device according to claim 1, wherein the base body and the base body diaphragm are made of silicon.

6. Sensor device according to claim 1, further comprising:
compensator material disposed on the base body and configured to generate pyroelectric charge under the effect of a temperature change; and
wherein the compensator material is configured so that the pyroelectric charge generated by said compensator material compensates for the pyroelectric charge generated by said sensor material.

7. Sensor device according to claim 6, wherein said compensator material is arranged outside the base body diaphragm.

8. Sensor device according to claim 7, further comprising:
a plurality of sensor electrodes;
wherein said sensor material defines a plurality of surfaces and is configured to generate the piezoelectric charge and the pyroelectric charge on the plurality of surfaces;
wherein a respective one of each of the plurality of sensor electrodes is disposed on a respective one of the plurality of the surfaces of the sensor material and configured to tap the piezoelectric charge and the pyroelectric charge;
wherein the base body diaphragm, the sensor material arranged on the base body diaphragm, and the sensor electrodes arranged on the surfaces of the sensor material form a pressure sensor;
wherein the compensator material defines a plurality of surfaces and is configured to generate the pyroelectric charge on the plurality of surfaces;
a plurality of compensator electrodes, wherein a respective one of each of the plurality of compensator electrodes is disposed on a respective one of the plurality of the surfaces of the compensator material and configured to tap the pyroelectric charge; and
a compensator that includes the compensator material disposed on the base body and the plurality of compensator electrodes arranged on the plurality of surfaces of the compensator material.

9. Sensor device according to claim 1, further comprising:
a plurality of base body diaphragms formed in said base body;
wherein each of the plurality of base body diaphragms is configured to undergo a deflection to sense the pressure to be measured and defines a front surface;
sensor material disposed on the front surface of each of the plurality of base body diaphragms, which sensor material defines a plurality of surfaces that are configured to generate piezoelectric charge under the effect of the deflection of said each of the base body diaphragms;
a plurality of sensor electrodes;
wherein a respective one of the plurality of sensor electrodes is disposed on a respective one of the plurality of surfaces of the sensor material and is configured to tap the piezoelectric charge; and
a plurality of sensor group conductors that electrically connect the sensor electrodes in series.

10. Sensor device according to claim 9, further comprising:
compensator material disposed on a plurality of regions of the base body and configured to generate pyroelectric charge under the effect of a temperature change;
wherein the sensor material is configured to generate pyroelectric charge under the effect of the temperature change;
wherein the plurality of sensor electrodes are configured to tap the piezoelectric charge and the pyroelectric charge of the sensor material;
a plurality of compensator electrodes;
wherein a respective one of the plurality of compensator electrodes is disposed on a respective one of the regions of the base body on which the compensator material is disposed and configured to tap the pyroelectric charge of the compensator material; and
a plurality of compensator group conductors that electrically connect the plurality of compensator electrodes in series.

11. Sensor device according to claim 6, further comprising:
a plurality of sensor electrodes;
a plurality of compensator electrodes;
wherein the generated piezoelectric charge of the sensor material includes a first piezoelectric charge and a second piezoelectric charge;
wherein the generated pyroelectric charge of the sensor material includes a first pyroelectric charge and a second pyroelectric charge;
wherein the plurality of sensor electrodes includes a first sensor electrode and a second sensor electrode;
wherein the first sensor electrode is configured to tap the first piezoelectric charge and the first pyroelectric charge of the sensor material;
wherein the second sensor electrode is configured to tap the second piezoelectric charge and the second pyroelectric charge of the sensor material;
wherein the generated pyroelectric charge of the compensator material includes a first pyroelectric charge and a second pyroelectric charge;
wherein the plurality of compensator electrodes includes a first compensator electrode and a second compensator electrode;
wherein the first compensator electrode is configured to tap the first pyroelectric charge of the compensator material;
wherein the second compensator electrode is configured to tap the second pyroelectric charge of the compensator material;
a transmission device that includes a first charge transmitter and a second charge transmitter;
wherein the first charge transmitter is electrically connected to the first sensor electrode and to the second compensator electrode, and configured to receive a first piezoelectric charge and a first pyroelectric charge of the sensor material and a second pyroelectric charge of the compensator material such that the magnitude of the first pyroelectric charge of the sensor material equals and compensates the magnitude of the second pyroelectric charge of the compensator material;
wherein the second charge transmitter is electrically connected to the second sensor electrode and to the first compensator electrode and configured to receive the second piezoelectric charge and the second pyroelectric charge of the sensor material and a first pyroelectric charge of the compensator material such that the magnitude of the second pyroelectric charge of said sensor material equals and compensates the magnitude of the first pyroelectric charge of the compensator material.

12. Sensor device according to claim 2, further comprising:
an interface;
wherein the piezoelectric charge of said sensor material includes a first piezoelectric charge;
wherein an electrical voltage of the electrical conductor includes a first electrical voltage;
wherein the interface configured to digitize a pressure signal corresponding to the first piezoelectric charge into a pressure data element with a pressure value;
wherein said interface is configured to provide the pressure data element with an associated pressure time point;
wherein the interface is configured to digitize a temperature signal corresponding to the first electrical voltage into a temperature data element with a temperature value; and
wherein said interface is configured to provide the temperature data element with an associated temperature time point.

13. Sensor device according to claim 12, further comprising:
a computing unit that includes a data memory electronically connected to a data processor;
wherein an evaluation program is stored in the data memory; and
wherein the data processor is configured to load the evaluation program into the data processor, and read into the evaluation program, the pressure data elements and the temperature data elements as well as the pressure time points associated with the pressure data elements and the temperature time points associated with the temperature data elements.

14. Sensor device according to claim 13, wherein the data processor is configured to run the evaluation program loaded into the data processor in a manner that combines a pressure data element, whose associated pressure time point is equal to the temperature time point associated with the temperature data element, with said temperature data element.

15. Sensor device according to claim 14,
wherein said computing unit includes a temperature correction data element that is stored in the data memory to include a further pressure value and a further temperature value assigned to the further pressure value;
wherein the data processor is configured to run the evaluation program loaded into the data processor so as to read in the temperature correction data element;
wherein the data processor is configured to run the evaluation program loaded into the data processor so as to identify a temperature correction data element whose associated further temperature value is equal to the temperature value of the combined temperature data element; and
wherein the data processor is configured to run the evaluation program loaded into the data processor so as to perform a subtraction of the further pressure value of the identified temperature correction data element from the pressure value of the pressure data element which is combined therewith, whereby the subtraction is configured to correct a temperature-dependent non-linearity of the sensitivity in the pressure value of the pressure data element.

16. Sensor device according to claim 3,
wherein the thickness of the base body diaphragm is less than or equal to 10 μm; and
wherein the diameter of said base body diaphragm is less than or equal to 200 μm.

17. Sensor device according to claim 3,
wherein the thickness of the base body diaphragm is less than or equal to 5 μm; and
wherein the diameter of said base body diaphragm is less than or equal to 100 μm.
